(19) United States
(12) Patent Application Publication
(10) Pub. No.: US 2010/0054851 A1
(43) Pub. Date: Mar. 4, 2010

(54) BALL-AND-SOCKET JOINT WITH SEALING RING

(75) Inventors: Manfred Bohne, Quernheim (DE); Manfred Heidemann, Belm-Vehrte (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/519,851

(22) PCT Filed: Dec. 17, 2007
(86) PCT No.: PCT/DE07/02267

§ 371 Date: Jun. 18, 2009

(30) Foreign Application Priority Data
Dec. 21, 2006 (DE) 10 2006 061 974.9

(51) Int. Cl. F16C 11/00

(52) U.S. Cl. 403/122

(57) ABSTRACT

A ball-and-socket or a bushing joint for a motor vehicle. The ball-and-socket joint has an essentially annular joint housing with an essentially cylindrical interior space in which a ball socket is arranged. The ball socket is fixed within the joint housing by a sealing ring and a ball, of a ball pin, is held within the ball socket. A surface of the sealing ring facing the ball socket has a radially outer portion that is smooth and a radially inner portion in contact with the ball socket that is serrated secures the ball socket from rotating within the joint housing. The ball-and-socket joint offers advantage with regard to the reduction in size, weight and manufacturing costs and the shorter tolerances in the area of the housing cover simplify production of the components and proportionally reduce manufacturing rejects.

This application is a National Stage completion of PCT/DE2007/002267 filed Dec. 17, 2007, which claims priority from German patent application serial no. 10 2006 061 974.9 filed Dec. 21, 2006.

### FILED OF THE INVENTION

The invention concerns a ball-and-socket joint, for example for an axle system or wheel suspension of a motor vehicle.

### BACKGROUND OF THE INVENTION

Ball-and-socket joints of the type are used, for example but by no means exclusively in the area of the wheel suspension or as bushing joints—for example for the articulation of transverse stabilizers, shock absorbers or spring damper systems—in motor vehicles.

The demands made on such balls or bushing joints include, in particular, high specific load-bearing capacity and small bearing play under both static and dynamic loading, as well as little or no need for maintenance, if possible over the lifetime of the motor vehicle or the ball joint itself, the lowest possible mass, and little structural space occupation. Furthermore, it should be possible to manufacture them inexpensively.

Usually, a ball-and-socket or a bushing joint has a joint housing of substantially annular-cylindrical or pot-shaped form inside which is arranged the bearing seat or ball socket. The ball socket must be anchored in the joint housing without play and in particular secured against rotation relative to the joint housing, since movements of the outer surface of the ball socket relative to the inner surface of the joint housing would result in wear and thus, prematurely, to undesired play which would shorten the life of the ball-and-socket joint.

In a ball or bushing joint known from the prior art it is sought to prevent the undesired rotation of the ball socket in the joint housing by providing the ball socket, in the area of the end of the joint housing on the cover side, with a projecting ball socket flange such that when the ball socket and the joint housing are joined to one another the ball socket flange comes to rest in contact with an circumferential step in the housing in the area of the joint housing cover, the step being of complementary shape to the ball socket flange. Thus, when the joint housing cover is fitted on, the projecting ball socket flange is gripped between the joint housing cover and the circumferential housing step in such manner that relative movements—in particular rotations between the ball socket and the joint housing—are prevented as much as possible.

Particularly in the context of the severe cost demands imposed in mass production on ball and bushing joints as well, the tool and production costs always associated with the production of the circumferential housing step in the joint housing, as in the prior art, should be regarded as critical.

Furthermore, the increases in the size of the respective tolerance chain in the axial direction of the joint housing, associated with the circumferential housing step and the ball socket flange, can tend to increase the proportion of production rejects or an insistence that correspondingly stricter accuracy requirements must be complied with in the production of the individual components, and this also tends to increase the production cost of such ball or bushing joints. Finally, the accuracy demanded in the production of both the ball socket flange and the circumferential housing step is comparatively high, since the desired security against rotation can only be ensured if the gripping forces required are accurately reproducible.

### SUMMARY OF THE INVENTION

Against that background the purpose of the present invention is to provide a ball-and-socket joint with which the disadvantages of the prior art are overcome. In particular, by virtue of the invention effective prevention of rotation between the ball socket and the joint housing should be achieved, along with improved robustness of the tolerance chain in the axial direction of the housing, and at the same time the production costs should be reduced.

In a manner known perse, the ball-and-socket joint according to the invention comprises, first, an essentially annular or pot-shaped joint housing. The joint housing has an essentially cylindrical inside space, in which the ball socket of the ball-and-socket joint is arranged, and the ball socket is fixed in the joint housing by means of a sealing ring. In turn, the ball of the ball in or ball bushing of the ball joint is held and able to undergo sliding movements within the ball socket.

According to the invention, however, the ball-and-socket joint is characterized in that on the outside of its end area adjacent to the sealing ring the ball socket is substantially of smooth cylindrical form. At the same time, on its end facing toward to ball socket the sealing ring of the joint housing is provided with serrations.

In this way, thanks to the substantially smooth cylindrical form of the end area of the ball socket adjacent to the sealing ring, in the first place the socket geometry is simplified in that the ball socket flange can be omitted, which already saves some tool and production costs. In addition, the circumferential housing step in the joint housing can also be omitted, and this saves further tool and production costs. Moreover, thanks to the omission of the all-round housing step in the joint housing, the diameter of the joint housing can also be reduced and this contributes toward reducing the structural space required and saving weight, these always being desirable from the design standpoint. Finally, owing to the design according to the invention the tolerance chain in the axial direction of the joint housing is also made shorter and simpler, and this contributes additionally to further cost savings and toward reducing the proportion of production rejects.

The always necessary securing of the ball socket against rotation in the joint housing is achieved according to the invention in that at its end facing toward the ball socket, the sealing ring is provided with serrations. At the moment when the joint housing is sealed by the sealing ring, the serrations can penetrate into the end of the joint housing on the cover side. In this way a secure, form-interlocking connection is made between the ball socket and the housing cover, and thus also between the ball socket and the joint housing, and this ensures the necessary security against rotation.

According to the invention the exact design form and arrangement of the serrations on the sealing ring are not critical, provided that a secure form interlock between the housing cover and the ball socket can be ensured by penetration of the serrations into the ball socket when the housing cover is fitted on. According to a particularly preferred embodiment of the invention, however, the serrations are arranged only in a radially inner zone of the area of the end of the sealing ring.

In particular, this makes it possible to use a radially outer zone of the area of the sealing ring for forming a sealing attachment between the sealing ring and the joint housing, the connection between the sealing ring and the joint housing preferably being formed by rolling/pressing. Thus, there is no need for serrations in the radially outer zone of the sealing ring, and this again saves costs in the production of the sealing ring.

In a further, also preferred embodiment of the invention, the serrations are formed by knurling. In this case the knurling preferably consists of a plurality of sharp-edged protrusions of substantially prismatic shape extending essentially radially on the ball socket side. Knurling of such a type can be produced on the sealing ring inexpensively and in particular without cutting machining, and requires only small pressing forces into the ball socket, while at the same time—in the sense of effectively preventing rotation—it enables high torque transfer between the ball socket and the sealing ring or joint housing.

In a further preferred embodiment of the invention, in longitudinal section along the axis of the joint housing the sealing ring has a cross-section with an essentially C-shaped contour. This design of the sealing ring in the first place saves material during its production, and in addition advantageously combines the functions of the joint housing cover or joint housing closure, anchoring the ball socket and securing it against rotation, fixing a joint sealing bellows and also, if needs be, acting as an abutment for the ball pin or ball bushing of the ball joint. Moreover a sealing ring of this design can be produced simply and inexpensively, particularly in the form of a pressed component.

To implement the invention it is not essentially critical how the connection between the joint housing cover and the joint housing itself is made. In a preferred embodiment of the invention, however, the sealing ring is flange-rolled over the joint housing at its end. This produces a particularly tight and durable closure of the joint housing without additional components. Moreover, the closure by flanging can be produced inexpensively and reliably.

In other embodiments of the invention, in the area of the side of the joint housing opposite the housing cover the inside space of the joint housing has a step that forms an axial abutment for the ball socket; alternatively, in the area of the side of the joint housing opposite the housing cover the diameter of the inside space of the joint housing decreases continuously in the axial direction of the joint housing.

Thanks to the step arranged in the inside space of the joint housing as an axial abutment for the ball socket, the ball socket can simply be pushed from the cover end into the joint housing as far as the step and the joint housing can then be closed by the housing cover. In this way, therefore, simple assembly and a defined location of the ball socket in the joint housing is achieved. In additional or alternatively, a continuously decreasing contour diameter of the inside space of the joint housing can also serve as an axial stop when the ball socket is fitted into the joint housing; moreover in this way, and having regard to the smaller wall thickness of the ball socket in this area, the rigidity of the ball socket can be increased as is desirable for many applications.

### BRIEF DESCRIPTION OF THE DRAWINGS

Below, the invention is explained in greater detail with reference to drawings which show embodiments, which are intended only as examples. The drawings show:

FIG. 1: Schematic illustration of an example of a ball-and-socket joint from the prior art, shown in isometric longitudinal section

FIG. 2: Bushing joint according to an embodiment of the invention, shown in longitudinal section

FIG. 3: Sealing ring of a bushing joint according to an embodiment of the invention, shown in longitudinal section

FIG. 4: The sealing ring of FIG. 3, viewed from above

FIG. 5: Schematic enlarged view of the seal area of a bushing joint according to the prior art

FIG. 6: Representation corresponding to FIG. 5, showing the seal area of the bushing joint in FIG. 2; and

FIG. 7: Further enlarged representations of a section of the knurled surface of the sealing ring of the bushing joint shown in FIG. 6

### DETAILED DESCRIPTION OF THE PREFERRED EMBODIMENTS

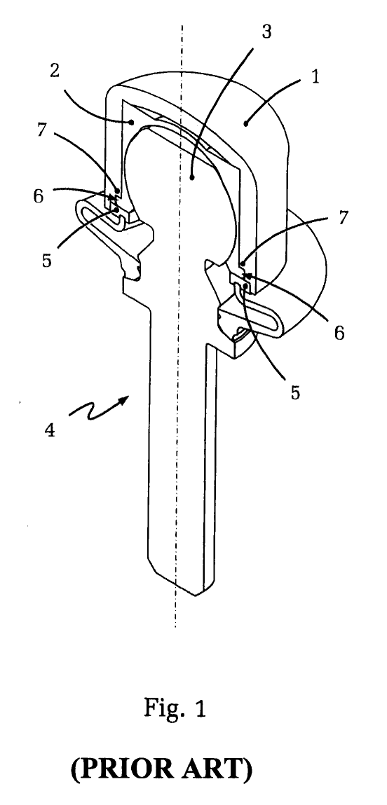

FIG. 1 shows a schematic longitudinal section of a ball-and-socket joint of the prior art. The figure shows the essentially pot-shaped joint housing 1 with the bearing seat or ball socket 2 arranged in it. In turn, the ball 3 of a ball pin 4 is arranged inside the inner space of the ball socket 2.

Furthermore, FIG. 1 also shows that the ball socket 2 is anchored in the joint housing 1 by means of a sealing ring 5 indicated only schematically, such that for the purpose of this anchoring and in particular to secure the ball socket 2 against rotation the ball socket 2 has a projecting ball socket flange 6 that extends radially outward in the area of its end adjacent to the sealing ring. The ball socket flange 6 is held in a housing step 7 of the joint housing 1 which also runs all the way round and has a shape complementary to that of the ball socket flange 6, so that the latter is gripped fast there between the sealing ring 5 and the joint housing 1.

As already mentioned earlier, however, in the example of the prior art illustrated the ball socket flange 6 and the housing step 7 are comparatively costly to produce, they result in an extension of the respective tolerance chain in the axial direction of the joint housing, and they also take up structural space especially in the radial direction in the area of the end of the joint housing on the cover side.

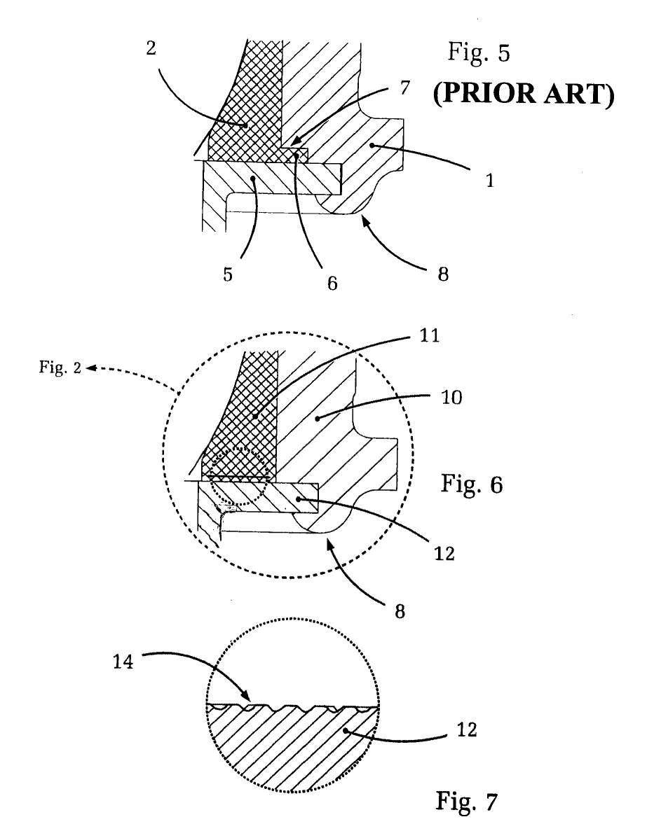

A further example from the prior art, which matches the representation shown in FIG. 1 as regards the anchoring of the ball socket 2 to secure it against rotation, is shown on an enlarged scale in FIG. 5. FIG. 5 shows the aperture of the joint housing at its end, part of the joint housing cover 5 and the associated end area of the ball socket 2. In addition the circumferential ball socket flange 6 of the prior art and present in this example as well, and the associated housing step 7 formed in the joint housing 1 can be seen, which here again are still needed in order to anchor the ball socket and in particular to prevent it from rotating, all these entailing the disadvantages already explained especially as regards production effort and manufacturing costs, structural space, and weight.

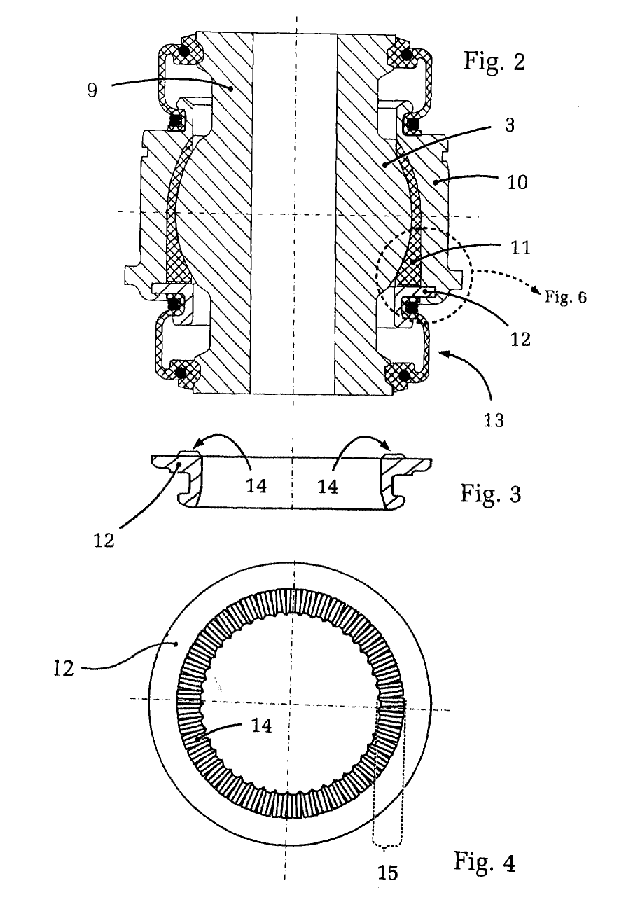

FIGS. 2 to 4 and 6 and 7 show embodiments of ball-and-socket or bushing joints according to the present invention, with which the above-mentioned disadvantages and limitations of the prior art are overcome.

FIG. 2 shows an embodiment of a bushing joint according to the present invention. One can see, first, the ball bushing 9, the joint housing 10 and the ball socket 11 arranged between the ball bushing 9 and the joint housing 10. In the embodiment shown, the bushing joint also has a closing cover 12 of essentially C-shaped cross-section. The closing cover 12 seals the joint housing 10, anchors the ball socket 11 in the joint housing 10 and also holds the joint-side end of a sealing bellows 13, and finally—in the sense of an advantageous combination of functions—it can also form an angle abutment that limits the angular deflection of the ball bushing 9 relative to the joint housing 10.

In FIG. 2 it can also be seen that in the area of the side of the joint housing 10 opposite the closing cover 12, the diameter of the inside space of the joint housing 10 decreases continuously in the axial direction of the joint housing. In this way a defined positioning of the ball socket 11 in the joint housing 10 is achieved during the assembly of the bushing joint, and with regard to the reduced wall thickness of the ball socket 11 in some areas, which is a feature of this design, the rigidity of the ball socket 11 is also increased thereby.

FIGS. 3 and 4 show the closing cover 12 of a further embodiment of a ball-and-socket or a bushing joint according to the invention. The closing cover 12 in FIGS. 3 and 4 is also designed to be flanged over a joint housing 10 and to hold a sealing bellows 13. In the representation shown in FIGS. 3 and 4 can be seen in particular the serration 14 of the closing cover 12 in the form of a circular zone of knurling. FIGS. 3 and 4 show that the serrations 14 of the closing cover 12 consist here of a plurality of sharp-edged, essentially radially extending and substantially prismatic protuberances arranged inside the circular zone 15.

FIGS. 6 and 7 again show, in each case on an enlarged scale, the serrations 14 or knurling of a closing cover 12 in an embodiment of a bushing joint according to the present invention. From FIG. 6 it can be seen that the joint closing cover 12 is connected to the joint housing 10 by a rolled-over flange 8. It can also be seen, in particular by considering FIGS. 5 and 6 together, that the geometry of the ball socket 11 and the joint housing 10 in the area of the connection to the closing cover 12 is considerably simpler in the ball joint according to the invention shown in FIG. 6, and can therefore be designed more inexpensively and also in a more space-saving manner than the prior art as illustrated in FIG. 5, since as a result of the invention both the ball socket flange 6 of the ball socket 2 of the prior art according to FIG. 5 and the housing step 7 of the joint housing 1 are omitted.

Consequently, it is clear that by virtue of the invention a ball-and-socket or a bushing joint is provided which, compared with the ball-and-socket or bushing joints known from the prior art, has advantages in relation to minimizing production costs and in relation to saving structural space and reducing weight. Thus, the invention contributes toward improving the cost-effectiveness and enlarging the possible range of application of ball-and-socket or bushing joints, particularly in the context of applications related to axle systems, wheel suspensions, or to articulate spring damper systems of the motor vehicle.

### LIST OF INDEXES

1 Joint housing
2 Ball socket
3 Joint ball
4 Ball pin
5 Sealing ring without serrations
6 Ball socket flange
7 Housing step
8 Rolled-over flange
9 Ball bushing
10 Joint housing
11 Ball socket
12 Closing cover with serrations
13 Sealing bellows
14 Serrations, knurling
15 Circular knurled zone

1-7. (canceled)

8. A ball-and-socket joint with a substantially annular or pot-shaped joint housing (10), the ball-and-socket joint having an essentially cylindrical inside space in which is arranged a ball socket (11) that is fixed to the joint housing (10) by a sealing ring (12), such that a ball (3), of either a ball pin (4) or a ball bushing (9), being held by the ball socket (11) and undergoes sliding movements therein, and
an end area of the ball socket (11), adjacent to the sealing ring (12), being a smooth cylinder while an end area of the sealing ring (12), facing the ball socket (10), having serrations (14).

9. The ball-and-socket joint according to claim 8, wherein the serrations (14) are only located in an inner, circular, ring-shaped partial zone (15) of the end area of the sealing ring (12) facing the ball socket (10).

10. The ball-and-socket joint according to claim 8, wherein the serrations (14) are knurls which comprises a plurality of sharp-edged, substantially radially extending and essentially prismatic protrusions on the end area of the sealing ring (12) facing the ball socket (10).

11. The ball-and-socket joint according to claim 8, wherein an axial cross-section of the sealing ring (12) is essentially C-shaped.

12. The ball-and-socket joint according to claim 8, wherein an end of the joint housing (10) is rolled over the sealing ring (12) to secure the sealing ring (12) to the joint housing (10).

13. The ball-and-socket joint according to claim 8, wherein the inside space of the joint housing (10), in an area of the joint housing opposite the housing cover, has a step which is an axial abutment for the ball socket (11).

14. The ball-and-socket joint according to claim 8, wherein the inside space of the joint housing (10), in an area of the joint housing opposite the housing cover, has a diameter which continuously decreases.

15. A ball-and-socket joint comprising:
a substantially cylindrical joint housing (10) with an interior surface and axially opposed first and second ends, the interior surface of the joint housing (10) being arcuate is shape such that the interior surface at the first end of the joint housing (10) has a smaller diameter than at the second end of the joint housing (10);
a ball (3) of a ball pin (4) and a ball socket (11) being accommodated within the joint housing (10) with the ball socket (11) being sandwiched between the ball (3) and the joint housing (10);
a sealing ring (12) securing the ball socket (11) within the joint housing (10), the sealing ring (12) having a radially interior zone (15) comprising serrations (14), and the serrations engaging the ball socket (11) to prevent rotation of the ball socket (11) with respect to the joint housing (10); and
one axial end of an annular sealing bellows (13) being retained by the sealing ring (12) and an opposed end of the sealing bellows (13) being coupled to the ball pin (4) to seal the joint housing (10).
